(19) United States
(12) Patent Application Publication
(10) Pub. No.: US 2018/0191520 A1
(43) Pub. Date: Jul. 5, 2018

(54) GATEWAY AND DIAGNOSING METHOD THEREOF

(71) Applicant: THOMSON LICENSING, Issy-les-Moulineaux (FR)

(72) Inventor: Qiang HE, Beijing (CN)

(21) Appl. No.: 15/739,681

(22) PCT Filed: Jun. 25, 2015
(86) PCT No.: PCT/CN2015/082339

§ 371 Date: Dec. 22, 2017

(51) Int. Cl. H04L 12/28; H04L 12/26; H04M 7/00; H04L 29/06

(52) U.S. Cl. CPC H04L 12/2898; H04L 63/1408; H04M 7/0024; H04L 43/08

(57) ABSTRACT

A gateway, a diagnosing method of gateway and a computer program product capable of enhancing security of the gateway with cheap and simple measure. The diagnosing method (200) of gateway comprises: identifying an abnormal behavior of the gateway (S210); and notifying the identified abnormal behavior to at least one terminal device (S220). A potential attack to a gateway may be detected as an abnormal behavior and sent to user of the gateway, such that the user of the gateway may be aware of the potential attack and administrate the configuration of the gateway, thus enhanced security may be achieved on the gateway.

### TECHNICAL FIELD

The present disclosure relates to the field of network technique, and particularly to a gateway, a diagnosing method thereof and a computer program product.

### BACKGROUND

Today, together with the fast growing broadband access to Internet, there is already a bunch of anti-virus solutions in various places. For example, anti-virus software may be installed and activated on a terminal device (for example, personal computer), and company firewall may be set and activated on a company or operator side.

However, for a device between a user-end device and an operator, it is still lack of protection on the personal data. For example, a gateway is a device between terminal devices (user-end devices) and a network server (operator). With the popularization of WiFi gateway, every day users heavily use Wifi gateway to access to the Internet.

For example, in case that the gateway is deliberately hacked, there is a high risk and possibility that personal information of an end-user may be visible for the hacker when the personal information of the end-user is inputted and sent to the hacked gateway through which the end-user accesses to the Internet. The personal sensitive information of the end-user may comprise but not limited to personal identification information, personal bank account information, financial account information, family member and family address, phone numbers, and so on. With the rapid development and popularization of electronic commerce (for example, amazon, eBay, etc.), more security issues on the gateway pop up day by day.

However, in many cases, the end-user has no idea whether the gateway he uses to surf online is in a “security” state or not. Actually, for most end-users, it is quite difficult for them to know whether the gateway is in the “security” state or not, and it is not realistic for them to use expensive company level solution to make the gateway safe.

### SUMMARY

According to one aspect of the embodiments of the present disclosure, there is provided a diagnosing method of gateway comprising: identifying an abnormal behavior of the gateway; and notifying the identified abnormal behavior to at least one pre-defined terminal device.

According to another aspect of the embodiments of the present disclosure, there is provided a gateway comprising: one or more processors, one or more storage means, and computer program instructions recorded on the one or more storage means and being executed by the one or more processors to perform following steps: identifying an abnormal behavior of the gateway; and notifying the identified abnormal behavior to at least one terminal device.

According to another aspect of the embodiments of the present disclosure, there is further provided a computer program product for diagnosing a gateway comprising computer program instructions downloadable from a communication network or comprising one or more computer readable storage media with computer program instructions recorded thereon, when the computer program instructions are executed by a processor, steps of the above diagnosing method of gateway are performed.

### BRIEF DESCRIPTION OF THE DRAWINGS

In order to more clearly describe the technical solutions of the embodiments of the present disclosure or the prior art, drawings necessary for describing the embodiments of the present disclosure or the prior art are simply introduced as follows. It should be obvious for those skilled in the art that the drawings described as follows only illustrate some embodiments of the present disclosure and other drawings can be obtained according to these drawings without paying any inventive efforts.

FIG. 1 is a schematic block diagram of a gateway to which a diagnosing method according to embodiments of the present disclosure is applied;

FIG. 2 is a schematic flowchart of a diagnosing method of gateway according to embodiments of the present disclosure;

FIG. 3 is a schematic flowchart of a diagnosing method of gateway according to a first embodiment of the present disclosure;

FIG. 4A is a schematic diagram of an automatic alert window according to the first embodiment of the present disclosure;

FIG. 4B is a schematic diagram of an notification webpage for notifying abnormal behavior of the gateway according to the first embodiment of the present disclosure;

FIG. 5 is a schematic flowchart of a diagnosing method of gateway according to a second and third embodiment of the present disclosure;

FIG. 6 is a schematic diagram of a web pushing message presented in a tablet according to the second embodiment of the present disclosure; and

FIG. 7 is a schematic diagram of a message presented in a terminal device according to the third embodiment of the present disclosure.

### DETAILED DESCRIPTION OF THE PREFERRED EMBODIMENTS

To illustrate the technical solutions of embodiments of the present disclosure clearly and fully, hereinafter, detailed descriptions will be made to the embodiments of the present disclosure in connection with the accompanying drawings. Obviously, the embodiments as described are only a part of the embodiments of the present disclosure, and are not all the embodiments of the present disclosure. All the other embodiments which are obtained by those skilled in the art based on the embodiments of the present disclosure without paying any inventive labor fall into the protection of the present disclosure.

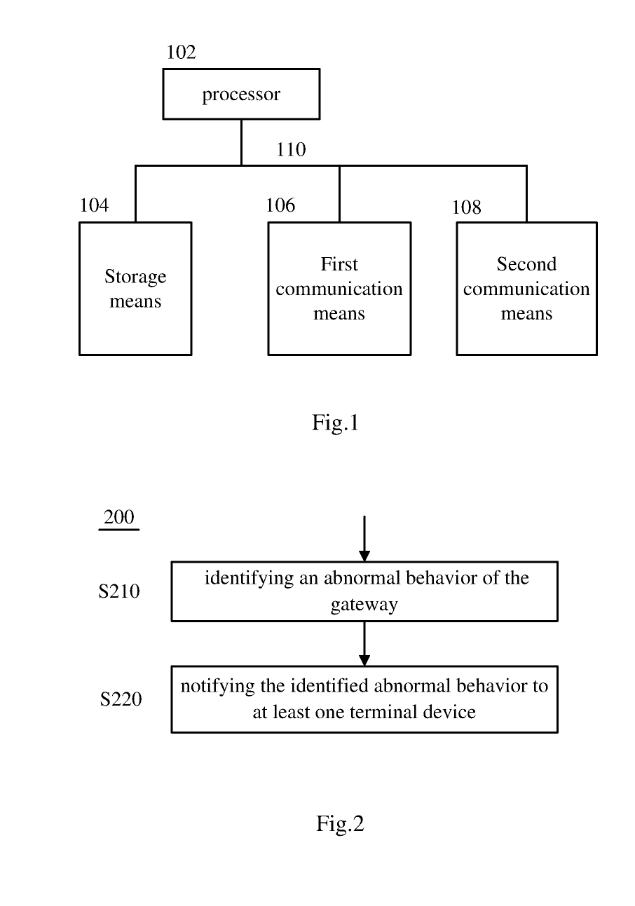

FIG. 1 is a schematic block diagram of a gateway to which a diagnosing method according to the embodiments of the present disclosure can be applied.

The gateway 100 comprises one or more processors 102, one or more storage means 104, one or more first communication means 106, and one or more second communication means 108, and a bus system 110. The one or more processors 102, one or more storage means 104, one or more first communication means 106, and one or more second communication means 108 are connected via the bus system 110. It should be noted that the components of the gateway 100 and the connection structure among these components are merely illustrative, but not limitative, and other components can also be included in the gateway 100 and other connection structure among the components can also be adopted according to actual requirement.

The processor 102 may be a central processing unit (CPU) or other processing units in other form and possessing data processing capability and/or instruction executing capability.

The storage means 104 may comprise one or more computer program products which can comprise computer readable storage media in various forms, for example non-volatile memory and/or volatile memory. The volatile memory may for example include random access memory and/or cache, etc. The non-volatile memory may for example include read only memory, hard disk, flash memory, etc. Computer program instructions can be recorded on the computer readable storage media, and can be executed by the processor 102 so as to implement function as described in the embodiments of the present disclosure and/or other desired functions.

The first communication means 106 may be adapted to communicate with network servers, and particularly receive and send data packets from and to the network servers. The second communication means 108 may be adapted to communicate with terminal devices, and particularly receive and send data packets from and to the terminal devices. In a particular implementation, the first communication means 106 may be a wired communication means, and the second communication means 108 may be a wireless communication means. However, it shall note that the present disclosure is not limited to this particular implementation.

As described above, the gateway may be hacked or tampered, most of users have no idea whether the gateway they are using is in the secure state or not, and more security issues on the gateway pop up day by day with the fast growing broadband access to Internet.

As an example, the gateway is hacked, and particularly a trusted DNS server in a domain name service (DNS) configuration in the gateway is changed or tampered, that is, the domain name service (DNS) configuration is filled with or overridden with a fake or rogue DNS server by a hacker or an attacker. When a user of a terminal device which is connected to the gateway and has access to Internet through the gateway requests a domain name “www.amazon.com” in a browser of the terminal device, the domain name is sent to the gateway and then forwarded to the fake DNS server according to the domain name service configuration in the gateway, and the fake DNS server then parses the domain name “www.amazon.com” to a fake IP address which is different from an real IP address of the website legally possessing the domain name “www.amazon.com”, and redirects the request to a fake amazon website with the fake IP address other than the desirable website “www.amazon.com”. That is, the fake amazon website is presented to the user through the terminal device. When the user logins with his user account information (including but not limited to account name and password) or pays on the fake amazon website, the hacker can obtain the account information of the user and the payment information (including but not limited to bank account information associated with the account information).

As another example, the gateway is hacked, and particularly the password of the gateway is hacked. Commonly, a terminal device of an authorized user can be connected to the gateway (through for example WiFi access) when the authorized user correctly inputs the password of the gateway on the terminal device. However, there are some illegal measures or software which can be adopted to crack the password of the gateway. After cracking the password of the gateway, the terminal device of the cracker may use the gateway to surf on the Internet, or even badly to surf on illegal website or publish illegal material.

In order to enhance the security of access to the Internet through the gateway, it is necessary for the end user who is using the gateway to know whether the gateway is in the secure state or not.

The present disclosure aims to provide automatic notification to an end user who is using the gateway when there are potential suspicious changes or risks detected on the gateway.

FIG. 2 is a schematic flowchart of a diagnosing method of gateway according to the embodiments of the present disclosure.

The diagnosing method 200 according to the embodiments of the present disclosure is implemented in the gateway 100 as shown in FIG. 1, and can offer functionality on the gateway to do automatic detection on the potential risk (or abnormal behavior of the gateway).

At step S210, an abnormal behavior of the gateway is identified.

On the gateway, it is easy to identify which behavior is “normal” and which behavior is “abnormal” based on common sense. For most of users, the below actions may be considered as normal behaviors or abnormal behaviors. The storage means stores the rules for determining if an action belongs to a category, e.g. normal behavior or abnormal behavior. The rules includes determination on if a value belongs to a list of stored values, determination on if a value has been changed by comparing to a stored value, determination on if a value exceeds a stored threshold value.

1. The password for an administrator account of the gateway does not always change. Commonly, the administrator account of the gateway and the password for the administrator account of the gateway are set once after the gateway is initially configured or reset. During normal operational procedure, the password for the administrator account of the gateway will not be changed. So, if the password for the administrator account of the gateway is changed frequently, it should be an abnormal behavior for the gateway and this might be a potential attack.

2. An access password (not the password for the administrator account) of the gateway does not always change. In other words, the trial for changing the access password only may happen in a very low frequency. So, if the access password of the gateway is changed in a frequency higher than a predefined frequency threshold, it may be an abnormal behavior for the gateway and may be a potential attack.

3. Commonly, the trial of WiFi access password happens in a low frequency or for a few times. For example, a user does not remember the WiFi access password clearly or just inputs a wrong WiFi access password by mistake, the user may try several times for the WiFi access password he does not remember clearly or just correctly input the WiFi access password. Under this circumstance, the trial of the WiFi access password happens for a few times, for example, 2 to 10 times, or in a low frequency, for example, 2-5 times per minute. If the trial of the WiFi access password happens in a high frequency, for example, more than 10 times per minute, or plenty of times, for example, more than 10000 times, it may be an abnormal behavior for the gateway and may be a potential attack, referred to as “WiFi password cracking”.

4. A domain name service (DNS) configuration on the gateway should use one of several predefined values. For a given country or district, there are several common DNS servers which provide functionality of domain name resolution. If the value of the DNS configuration on the gateway is not one of the several predefined values, it may be an abnormal behavior for the gateway and may be a potential attack.

5. A remote control function of the gateway is always off during the normal operational procedure. In case that the remote control function of the gateway is ON, the gateway can be controlled and parameters of the gateway may be modified online by a remote device, e.g. a remote computer, which means that the security level of the gateway is currently very low and is easy to be hacked. So, if the remote control function of the gateway is ON, it may be an abnormal behavior for the gateway and may be a potential attack. Optionally, if a remote control is received from the Internet, it can also be considered as an abnormal behavior according to actual requirement.

6. A DMZ (demilitarized zone) configuration should use its default value. If the DMZ configuration of the gateway is changed from the default value, it may be an abnormal behavior for the gateway and may even be a potential attack.

7. A firewall rule configuration of the gateway should always use its default value. For example, the firewall rule configuration of the gateway may have values including high, medium, low and disabled, and the default value of the firewall rule configuration of the gateway is medium. If the default value of the firewall rule configuration of the gateway is set to “low” or “disabled”, it may be an abnormal behavior for the gateway and may be a potential attack.

8. A terminal device connected to the gateway only does normal package exchange with the gateway. If a huge amount of package exchange with the gateway occurs in a short time (i.e. the number of exchanged packages within a given period of time exceeds a threshold), it may be an abnormal behavior for the gateway and may be a potential attack. For example, a package amount threshold may be set in the gateway, if the amount of package exchange in a predefine time unit is beyond the package amount threshold, it may be an abnormal behavior for the gateway. In addition, the package exchange habit may be recorded according to the end user's normal behavior, for example, on every weekday, the package exchange only happens from 19:00 to 24:00. If the big amount package exchange happens at 05:00 of a weekday, it may be an abnormal package exchange for the gateway and may be a potential attack.

9. A name of a terminal device newly connected to the gateway should match with one of predefined names of terminal devices. For example, we commonly know and use the following names of terminal device as the predefined names of terminal devices which may be referred to as friendly name of the terminal devices: APPLE, SAMSUNG, HTC, GOOLE, LENOVO, HUAWEI, MI, etc. If a name of a newly connected terminal device is, for example, DDEEFF which obviously does not belong to a list of the predefined names of terminal devices, the newly connected terminal device may come from a district far away from the district where the gateway is located, for example, it may be a strange terminal device for a user in Europe, America, or China. In other words, it may be an abnormal behavior for the gateway and may be a potential attack.

It should be noted that the normal behavior and the abnormal behavior are not so limited, those skilled in the art can define the normal behavior and the abnormal behavior according to actual requirement.

At step S220, the identified abnormal behavior is notified to at least one terminal device.

At least one terminal device may comprise a terminal device which is connected to the gateway or a terminal device which is not connected to the gateway. In addition, the notification may be presented to the user in a webpage form, a pop-up window form, or in a text message form, and the notification may be implemented only through the gateway or through a combination of the gateway and another message managing server.

Below, three particular embodiments will be described to illustrate the principle of the embodiments of the present disclosure.

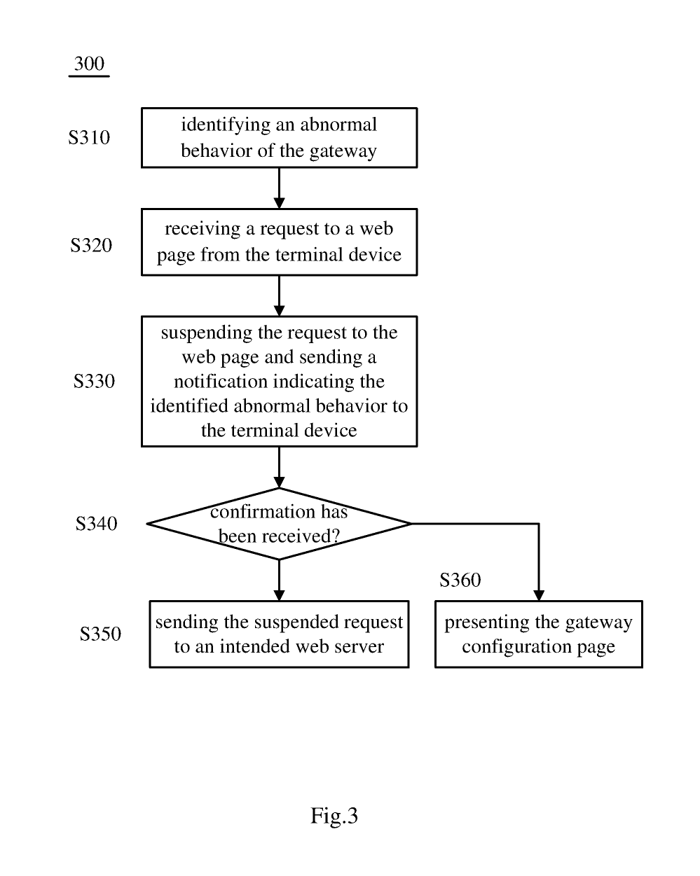

FIG. 3 is a schematic flowchart of a diagnosing method of gateway according to a first embodiment of the present disclosure.

The diagnosing method as shown in FIG. 3 is implemented in the gateway. In the first embodiment, the identified abnormal behavior is notified to a terminal device which is connected to the gateway. For example, the terminal device may be a tablet, a notebook computer, a desk top computer, a smart phone and other devices which have capability of accessing Internet through the gateway.

At step S310, an abnormal behavior of the gateway is identified. The operation of the step S310 is same as that of the step S210, and repeated description is omitted herein for sake of simplicity.

At step S320, a request to a web page is received from the terminal device. For example, the user of the terminal device requests a webpage of the domain name “www.amazon.com” or any other web site in a browser of the terminal device.

At step S330, the identified abnormal behavior is notified to the terminal device.

Particularly, at this step, the request to the web page is suspended in the gateway, and a notification is sent to the terminal device to indicate that an abnormal behavior is detected or identified in the gateway.

In this first embodiment, the notification can be presented in multiple levels, for example, the notification may only indicate that an abnormal behavior is identified in a first level, and then indicate particular change in the parameter value corresponding to the identified abnormal behavior in a second level; or the notification may indicate the type of an identified abnormal behavior in a first level, and then indicate particular change in the parameter value corresponding to the identified abnormal behavior in a second level; or the notification may indicate particular change in the parameter value corresponding to the identified abnormal behavior directly in a first level. In this first embodiment, each of the multiple levels of the notification may be implemented in a webpage form or in a pop-up window form.

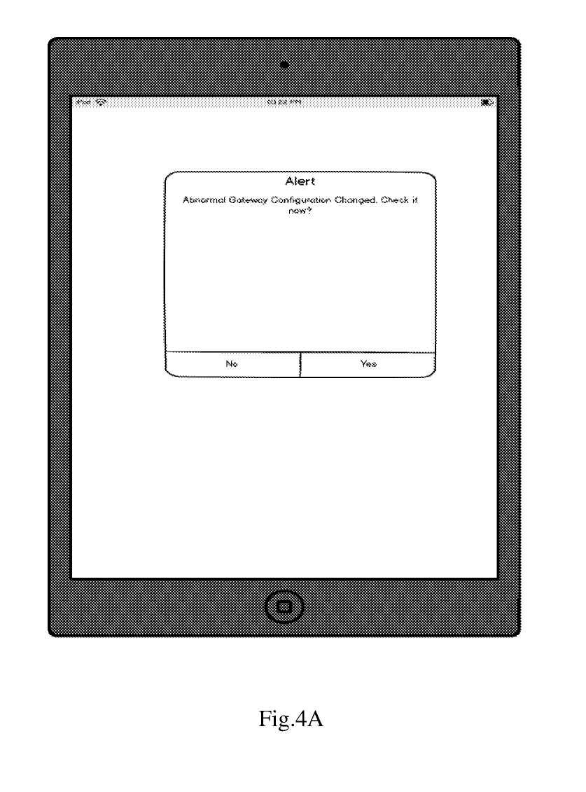

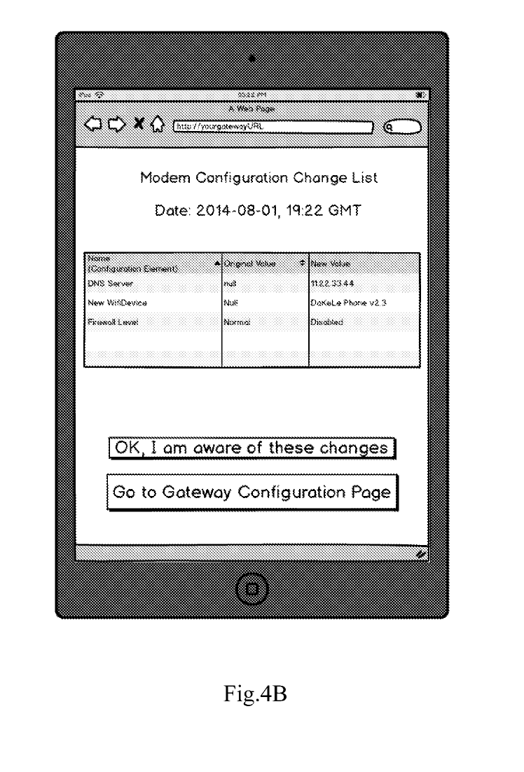

FIG. 4A illustrates a schematic diagram of a notification in a first level in a pop-up window. As shown in FIG.4A, the notification only indicates that an abnormal behavior is identified. If the user selects “Yes” in the window as shown in FIG. 4A, a summary page for the identified abnormal behavior for example as shown in FIG. 4B may be presented in a webpage form in a second level.

It can be seen from FIG. 4B as an example that the DNS configuration of the gateway has been changed from its original value “null” (which means that a default value is used) to a new value “11.22.33.44”, the firewall level configuration of the gateway has been changed from its original value “Normal” to a new value “Disabled”, and a newly added Wifi Device is DaKeLe Phone v2.3.

Of course, the pop-up window as shown in FIG. 4A can alternatively indicate that the DNS configuration of the gateway has been changed in a first level. When the user selects “Yes” in the pop-up window as shown in FIG. 4A, the summary page as shown in FIG. 4b can then be presented in a second level.

Alternatively, the pop-window as shown in FIG. 4A is not necessary. Under this circumstance, the notification is directly in a webpage form and is a summary page of the identified abnormal behavior. It should be noted that the identified abnormal behavior may be one or more identified abnormal behaviors currently existing in the gateway.

Then, at step S340, it is determined whether a confirmation to the identified abnormal behavior is received.

After the user selects “No” in the pop-up window as shown in FIG. 4A or “OK, I am aware of these changes” in the notification webpage as shown in FIG. 4B, the diagnosing method according to the first embodiment of the present disclosure determines that the identified abnormal behavior is confirmed by the user at step S340, that is, at step S340, a confirmation to the identified abnormal behavior is received from the user, and then the suspended request to the web page is sent to an intended web server, that is, the DNS server “11.22.33.44”, at step S350.

After the user selects “Go to Gateway Configuration Page”, the diagnosing method according to the first embodiment of the present disclosure determines that the identified abnormal behavior is not confirmed by the user at step S340, that is, at step S340, a confirmation to the identified abnormal behavior is not received from the user, the gateway configuration page may be presented at step S360 for correction of the gateway configuration.

In the first embodiment, the terminal device is the authorized device, which has been recognized as a safe device by the gateway. For example, the authorized device may be recognized as the safe device according to the operation history or access history of the gateway and the terminal devices connected to the gateway, and/or notification destination settings in the gateway. The access history of a terminal device which accesses network through the gateway includes at least one of registration time and total access time, and the notification destination settings may be set by an operator of the gateway in advance and may include the identification of the terminal device which is considered as a safe device by the operator.

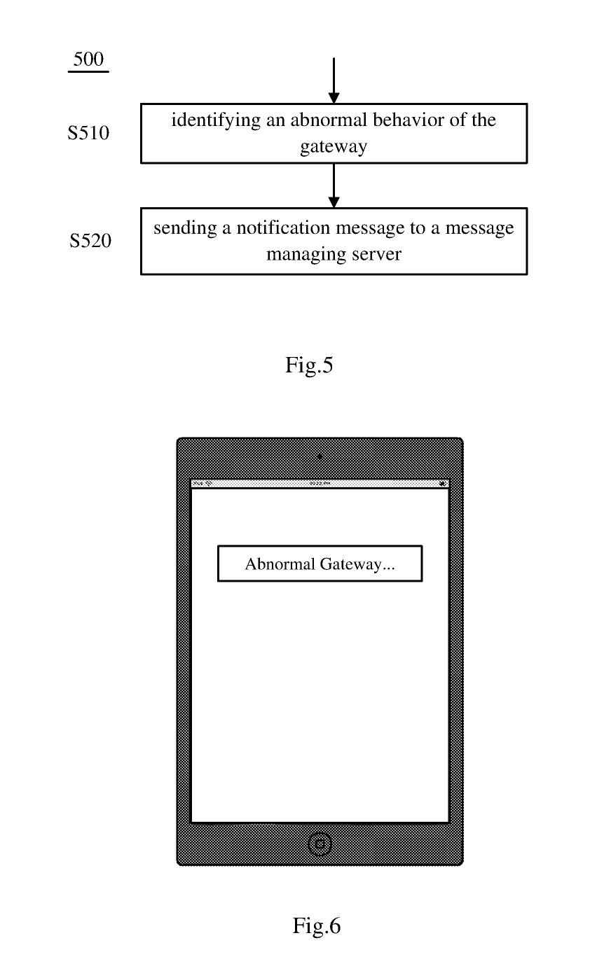

FIG. 5 is a schematic flowchart of a diagnosing method of gateway according to a second and third of the present disclosure. The diagnosing method as shown in FIG. 5 is implemented in the gateway.

At step S510, an abnormal behavior of the gateway is identified. The operation of the step S510 is same as that of the step S210, and repeated description is omitted herein for sake of simplicity.

At step S520, a notification message is sent to one or more message managing servers, the notification message comprises an indication of the identified abnormal behavior and destination information of the indication of the identified abnormal behavior.

In the second embodiment, the destination information may include at least one of an identification of the gateway in which the identified abnormal behavior happens and an identification of each of the at least one terminal device. Here, the identification of the gateway may be a unique serial number allocated by the manufacture of the gateway, or may be a gateway name set by the user of the gateway; the identification of the terminal device may be a unique serial number allocated by the manufacture of the terminal device, or may be a terminal device name set by the user of the terminal device. Here, the destination information may be used by a terminal device which has received the indication of the identified abnormal behavior to determine whether the terminal device is the destination of the indication of the identified abnormal behavior and whether the terminal device should present the indication of the identified abnormal behavior.

In the second embodiment, said one or more message managing servers may include at least one message pushing server, which pushes a web pushing message indicating the identified abnormal behavior to the at least one terminal device according to the notification message.

For example, for Apple devices, there is an Apple Notification Server which can push a notification to the Apple devices; for Android devices, there is a Cloud to Device Messaging (C2DM) server which can push a notification to the Android devices; and for Windows Phone devices, there is a Microsoft Pushing Notification Server (MPNS) which can push a notification to the Windows Phone devices.

Optionally, in the second embodiment, said message managing server may further include a central managing server, the central managing server receives the notification message and sends a request for pushing notification to the at least one message pushing server, the request for pushing notification may include the indication of the identified abnormal behavior and the destination information of the indication. Then, each of the at least one message pushing server pushes a message including the indication of the identified abnormal behavior and the corresponding destination information to the at least one terminal device.

As an example, a specific application may be installed in each of the at least one terminal device, and parameters of the specific application may be set, for example, one parameter may specify the identification of the gateway with which the terminal device is responsible for receiving the web pushing message. For example, assuming that a web pushing message includes an indication of the identified abnormal behavior “AAAAA” and an identification of a gateway “BBBBB”, when a terminal device receiving the web pushing message has been assigned to present a web pushing message associated with a gateway having an identification of “BBBBB”, the terminal device will present the received web pushing message; on the other hand, when a terminal device receiving the web pushing message has been assigned to present a web pushing message associated with a gateway having an identification of “CCCCC” different from the identification of the gateway included in the web pushing message, the terminal device will not present the received web pushing message. In this way, each of the at least one terminal device can only present the web pushing message concerning a specific gateway with which the terminal device is associated or for which the terminal device is responsible.

As another example, each of the notification message and web pushing message comprises an indication of the identified abnormal behavior and an identification of each of the at least one terminal device. For example, a specific application may be installed in each of the at least one terminal device. A terminal device receiving the web pushing message determines whether to present the received web pushing message based on comparison between its own identification and the identification of the at least one destination terminal device included in the web pushing message.

In the second embodiment, the terminal device may be a tablet, a notebook computer, a desk top computer, a smart phone and other devices which have capability of accessing Internet via the gateway or by other means.

FIG. 6 illustrates an exemplary web pushing message presented in a tablet according to the second embodiment of the present disclosure.

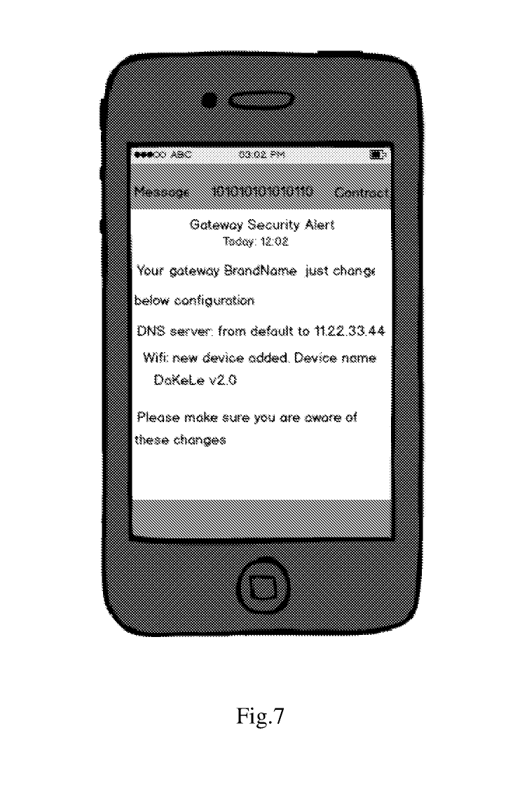

FIG. 7 illustrates an exemplary message presented in a terminal device according to the third embodiment of the present disclosure.

In the third embodiment, the at least one terminal device is at least one mobile phone, and said one or more message managing servers may include at least one message sending server which sends a text message indicating the identified abnormal behavior to the at least one mobile phone according to the destination information included in the notification message. For example, the message may be a text message to the mobile phone.

In the third embodiment, the destination information may include at least one of the identification of the gateway in which the identified abnormal behavior happens and a phone number of each of the at least one mobile phone.

In case that the destination information includes the phone number of each of the at least one mobile phone, the at least one message sending server receives the notification message and sends a short message including the indication of the identified abnormal behavior to the at least one terminal device.

In case that the destination information includes the identification of the gateway in which the identified abnormal behavior happens, the at least one message sending server stores in advance therein phone number of at least one mobile phone associated with the gateway in which the identified abnormal behavior happens and being destination of the indication of the identified abnormal behavior of the gateway. Preferably, the phone number of at least one mobile phone and the identification of the gateway are associated and stored in the at least one message sending server.

For example, there are two message sending servers A and B, there are two mobile phones AA and BB associated with a specific gateway G, and the mobile phone AA can receive a short message from the message sending server A and the mobile phone BB can receive a short message from the message sending server B. When the gateway detects an abnormal behavior, it sends a notification message including the indication of the identified abnormal behavior and the identification of the gateway. The message sending server A determines the phone number of the mobile phone AA according to the identification of the gateway included in the notification message and sends a short message indicating the identified abnormal behavior of the gateway to the mobile phone AA, and the message sending server B determines the phone number of the mobile phone BB according to the identification of the gateway included in the notification message and sends a short message indicating the identified abnormal behavior to the mobile phone BB.

Optionally, in the third embodiment, said one or more message managing servers may further include a central managing server, and the central managing server receives the notification message and sends a request for sending text message to the at least one message sending server.

In case that the destination information includes the phone number of each of the at least one mobile phone, the request for sending short message may include the indication of the identified abnormal behavior and the phone number of each of the at least one mobile phone. Then, the at least one message sending server sends a text message including the indication of the identified abnormal behavior to the at least one terminal device.

For example, in case that the destination information includes the identification of the gateway in which the identified abnormal behavior happens, and the central managing server stores in advance therein phone number of at least one mobile phone associated with the gateway in which the identified abnormal behavior happens and being destination of the indication of the identified abnormal behavior of the gateway. Preferably, the phone number of at least one mobile phone and the identification of the gateway are associated and stored in the central managing server. The central managing server receives the notification message and determines the phone number of each of the at least one mobile phone associated with the gateway, and sends a request for sending short message including the indication of the identified abnormal behavior and the phone number of the at least one terminal device to the at least one message sending server. Then, the at least one message sending server sends a short message including the indication of the identified abnormal behavior to the at least one terminal device.

Of course, the identification of the gateway and the phone number of at least one mobile phone associated with the gateway and being destination of the indication of the identified abnormal behavior of the gateway may be stored in the one or more message sending servers rather than in the central managing server. In this case, the central managing server receives the notification message and sends a request for sending short message including the indication of the identified abnormal behavior and the identification of the gateway to the at least one message sending server, and then the at least one message sending servers determines the phone number of the at least one terminal device according to the identification of the gateway included in the request for sending short message.

The diagnosing method of gateway according to the first, second and third embodiment can be performed by the processor 102 of the gateway 100 as shown in FIG. 1. Particularly, the storage means 104 stores program instructions, when the program instructions stored in the storage means 104 are executed by the processor 102 of the gateway 100, the diagnosing method of gateway according to the first, second and third embodiment can be implemented.

Therefore, in the embodiments of the present disclosure, there is further provided a gateway comprising one or more processors, one or more storage means, one or more first communication means, and one or more second communication means. Computer program instructions are recorded in the one or more storage means, and can be executed by the processor, such that the steps in the diagnosing method of gateway according to the first, second and third embodiment can be implemented.

Furthermore, in the embodiments of the present disclosure, there is further provided a computer program product for diagnosing a gateway, the computer program product comprises computer program instructions downloadable from a communication network or includes one or more computer readable storage media with computer program instructions recorded thereon, the computer program instructions can be executed by the processor such that the processor performs the diagnosing method of gateway according to the first, second and third embodiment.

According to the embodiments of the present disclosure, the abnormal behavior of the gateway may be automatically detected by the gateway, and a notification concerning the detected abnormal behavior may be sent to the user, the authorized user or the administrating operator in several manners, such that the user, the authorized user or the administrating operator can know the potential attack as soon as possible.

Furthermore, it is provided a computer program product downloadable from a communication network and/or recorded on a medium readable by computer and/or executable by a processor, comprising program code instructions for implementing the steps of a method as aforementioned.

Furthermore, it is provided Non-transitory computer-readable medium comprising a computer program product recorded thereon and capable of being run by a processor, including program code instructions for implementing the steps of a method as aforementioned.

It should be appreciated that the above embodiments are only for illustrating the principle of the present disclosure, and in no way limit the scope of the present disclosure. It will be obvious that those skilled in the art may make modifications, variations and equivalences to the above embodiments without departing from the spirit and scope of the present disclosure as defined by the following claims.

1. A diagnosing method of a gateway, comprising:
identifying an abnormal behavior of the gateway; and
notifying the identified abnormal behavior to at least one terminal device.

2. The diagnosing method of claim 1, before notifying the identified abnormal behavior to the terminal device, the diagnosing method further comprises:
receiving a request to a web page from a terminal device,
wherein said notifying the identified abnormal behavior to the terminal device further comprises:
suspending the request to the web page and sending a notification indicating the identified abnormal behavior to the terminal device.

3. The diagnosing method of claim 2, further comprising:
receiving a confirmation of the abnormal behavior and sending the request to the web page to an intended web server.

4. The diagnosing method of claim 1, wherein said notifying the identified abnormal behavior to at least one terminal device further comprises:
sending a notification message to one or more message managing servers, the notification message comprising an indication of the identified abnormal behavior and destination information of the indication of the identified abnormal behavior.

5. The diagnosing method of claim 4, wherein said one or more message managing server comprises at least one message pushing server, which pushes a web pushing message indicating the identified abnormal behavior to the at least one terminal device according to the notification message, the web pushing message includes the indication of the identified abnormal behavior and the destination information of the indication of the identified abnormal behavior, wherein each of the at least one terminal device determines whether to present the received web pushing message according to the destination information of the indication of the identified abnormal behavior.

6. The diagnosing method of claim 4, wherein said at least one terminal device is at least one mobile phone, and said one or more message managing servers comprise at least one message sending server which sends a message indicating the identified abnormal behavior to the at least one mobile phone according to the destination information included in the notification message.

7. The diagnosing method of claim 1, wherein the at least one terminal device is at least one authorized device, each of which has been recognized as a safe device in the gateway according to at least one of operation history of the gateway, access history of the terminal devices connected to the gateway, and notification destination settings in the gateway,
wherein the access history of a terminal device which accesses network through the gateway includes at least one of registration time, total access time, access period, time or amount of packet exchange; and
the notification destination settings are set on the gateway in advance and include the identification of the terminal device which is listed as a safe device.

8. The diagnosing method of claim 1, wherein the abnormal behavior of the gateway comprises at least one of following behaviors:
a password for an administrator account of the gateway is changed;
an access password of the gateway is changed in a frequency higher than a first predefined frequency threshold;
a wifi-access trial happens in a frequency higher than a second predefined frequency threshold;
a domain name service DNS configuration on the gateway is different from a default DNS configuration;
a remote control to the gateway is received or a remote control function of the gateway is turned on;
a demilitarized zone DMZ configuration is different from a default DMZ configuration;
a firewall rule configuration is different from a default firewall rule configuration;
number of exchanged packages within a given period of time through the gateway exceeds a threshold; and
a name of a newly added device in the gateway is different with any of preset names of terminal devices.

9. A gateway comprising:
one or more processors,
one or more storage means storing computer program instructions being executed by the one or more processors to perform following steps:
identifying an abnormal behavior of the gateway; and
notifying the identified abnormal behavior to at least one terminal device.

10. The gateway of claim 9, when the computer program instructions are executed by the one or more processors, the following steps are performed:
receiving a request to a web page from a terminal device, and suspending the request to the web page and sending a notification indicating the identified abnormal behavior to the terminal device to notify the identified abnormal behavior to at least one terminal device.

11. The gateway of claim 9, wherein said notifying the identified abnormal behavior to at least one terminal device comprises:
sending a notification message to one or more message managing servers, the notification message comprising an indication of the identified abnormal behavior and destination information of the indication of the identified abnormal behavior.

12. The gateway of claim 11, said one or more message managing server comprises at least one message pushing server, which pushes a web pushing message indicating the identified abnormal behavior to the at least one terminal device according to the notification message, the web pushing message includes the indication of the identified abnormal behavior and the destination information of the indication of the identified abnormal behavior,
wherein each of the at least one terminal device determines whether to present the received web pushing message according to the destination information of the indication of the identified abnormal behavior.

13. The gateway of claim 12, wherein said at least one terminal device is at least one mobile phone, and said one or more message managing servers comprise at least one message sending server which sends a message indicating the identified abnormal behavior to the at least one mobile phone according to the destination information included in the notification message.

14. The gateway of claim 13, wherein the destination information includes at least one of the identification of the gateway and a phone number of each of the at least one mobile phone,
wherein said at least one message sending server stores phone number of at least one mobile phone and the gateway in which the identified abnormal behavior happens in association relationship, and determines the phone number of at least one mobile phone according to the identification of the gateway in case that the destination information includes the identification of the gateway,
wherein said at least one message sending server sends a message to the at least one mobile phone with the phone number.
